(19) United States
(12) Patent Application Publication
(10) Pub. No.: US 2004/0029533 A1
(43) Pub. Date: Feb. 12, 2004

(54) Wireless transmitting apparatus, wireless communication system and a method of wireless transmission

(75) Inventors: Ryoko Matsuo, Tokyo (JP); Koji Horisaki, Tokyo (JP); Tsuguhide Aoki, Tokyo (JP); Hiroki Shoki, Tokyo (JP); Hiroshi Tsurumi, Tokyo (JP); Shuichi Obayashi, Tokyo (JP); Osamu Shibata, Tokyo (JP); Hideo Kasami, Tokyo (JP); Kuniaki Ito, Tokyo (JP); Takayoshi Ito, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/440,116

(22) Filed: May 19, 2003

(30) Foreign Application Priority Data
May 17, 2002 (JP) 2002-143560

(51) Int. Cl. H04L 27/04; H04L 27/12

(52) U.S. Cl. 455/63.1; 455/562.1; 375/299

(57) ABSTRACT

A wireless transmitting apparatus according to the present invention, comprising: N (N is two or more integer) pieces of antennas capable of transmitting a wireless signal; and a selector which selects L (L is one or more integer, and L≦N) pieces of antennas from said N pieces of antennas and selects the types of signals to be transmitted from the selected L pieces of antennas.

### CROSS REFERENCE TO RELATED APPLICATIONS

This application claims benefit of priority under 35USC§119 to Japanese Patent Application No. 2002-143560, filed on May 17, 2002, the entire contents of which are incorporated by reference herein.

### BACKGROUND OF THE INVENTION

1. Field of the Invention

The present invention relates to a wireless transmitting apparatus, a wireless communication system and a method of wireless transmission which communicates a wireless signal by using a plurality of antennas.

2. Related Art

FIG. 6 is a block diagram showing schematic configuration of a conventional wireless communication system. The wireless communication system of FIG. 6 has a transmitting apparatus 30 having a plurality of transmission antennas 1a-1d, and a receiving apparatus 40 having a plurality of reception antennas 4a-4d. The transmitting apparatus 30 transmits different transmission symbols on the same resource (for example, the same time or the same frequency) from a plurality of transmission antennas 1a-1d. The receiving apparatus 40 receives the transmission symbols transmitted from the transmitting apparatus 30 by using the reception antennas 4a-4d.

The wireless communication system of FIG. 6 improves communication quality per one user by using the transmission symbols with redundancy to each other by the transmission antennas 1a-1d, as compared with a wireless communication system using a single antenna. The technique increasing transmission capacity by cooperation of a plurality of transmission antennas 1a-1d is called as transmission diversity.

In order to improve communication quality, coding is performed at a transmission side, and a plurality of transmission antennas transmit different transmission symbols on the same resource, such as a space-time coding and a space-time block coding.

According to these methods, although it is possible to improve communication quality, the following drawbacks occur.

1. Power consumption increases.

2. When there is a correlation in propagation path status between a transmitter and a receiver, communication capacity lowers, that is, a diversity gain is not obtained. Therefore, an advantage by using a plurality of antennas is lost.

The technique called as a MIMO (Multiple Input Multiple Output), which increases communication capacity by providing a plurality of antennas at transmitted side and received side, is proposed.

In the MIMO, although it is possible to increase communication capacity, the following drawbacks occur.

3. Decryption processing at received side becomes heavy.

4. Power consumption increases.

There is a problem in which power consumption is spent in vain and useless signal processings are performed, when the propagation path status is terrible.

As these countermeasures, D. A. Gore et al. of Stanford University publishes at an International convention a research for expressing in matrixes the propagation path status between the transmitter and the receiver, and selecting the number of transmission antennas in accordance with ranks of matrixes (“Selecting an optimal set of transmit antennas for a low rank matrix channel”, Gore, D. A.; Nabar, R. U.; Paulraj, A. Acoustics, Speech, and Signal Processing, 2000. ICASSP '00. Proceedings. IEEE International Conference on , Volume: 5 2000, PP.2785-2788 vol.5).

It is assumed that various information in which the amount of information and property of information are completely different is transferred, and each user transmits different information such as priority. In this case, in current transmission diversity, there is a problem in which a control in accordance with the required quality is impossible.

### SUMMARY OF THE INVENTION

An object of the present invention is to provide a wireless transmitting apparatus, a wireless communication system and a method of wireless transmission capable of reducing power consumption, improving communication quality, and performing control in accordance with request quality.

According to the present invention, a wireless transmitting apparatus, comprising:

N (N is two or more integer) pieces of antennas capable of transmitting a wireless signal; and

a selector which selects L (L is one or more integer, and L≦N) pieces of antennas from said N pieces of antennas and selects the types of signals to be transmitted from the selected L pieces of antennas.

### BRIEF DESCRIPTION OF THE DRAWINGS

FIG. 1 is a diagram showing a schematic configuration of a first embodiment of a wireless communication system according to the present invention.

FIG. 2 is a block diagram showing one example of internal configuration of a baseband signal processor.

FIG. 3 is a flowchart showing processing procedure of a selector of the first embodiment.

FIG. 4 is a flowchart showing processing procedure of a selector of the second embodiment.

FIG. 5 is a block diagram showing schematic configuration of a fourth embodiment of a wireless communication system according to the present invention.

FIG. 6 is a block diagram showing schematic configuration of the conventional wireless communication system.

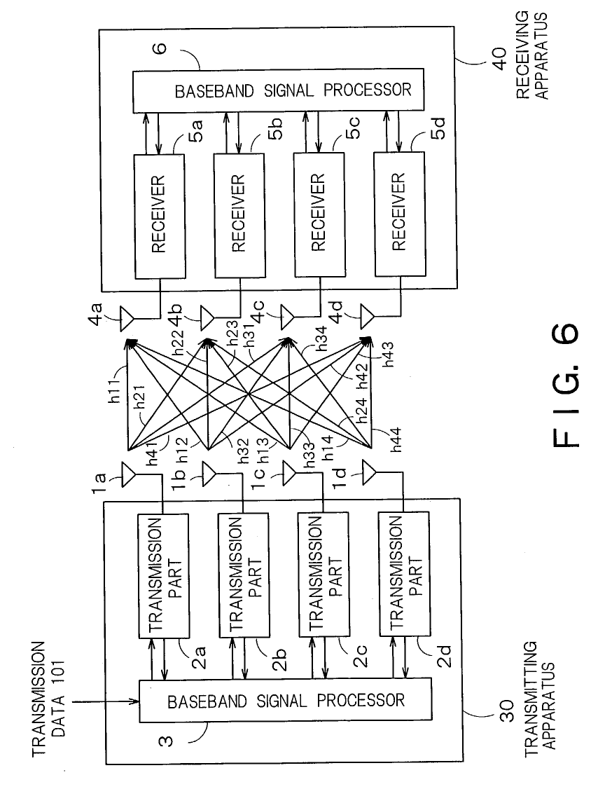

### DESCRIPTION OF THE PREFERRED EMBODIMENTS

Hereinafter, a wireless transmitting apparatus, a wireless communication system, and a method of wireless transmission according to the present invention will be more specifically described with reference to drawings. The present invention has a feature in which the number of antennas and a method of transmitted and received diversity by a plurality of antennas are selected based on propagation path status and transmission information.

As the properties of information, it is assumed that various information such as binary data, image (moving image), sound and streaming data for distributing information to a lot of people, and information adding priorities which relate to transmission order for each user and is set for each user may be included in the information.

As a method for selecting the number of antennas used for transmission and reception and the information transmitted and received by a plurality of antennas, the following two methods are mainly supposed. One method is to select the information transmitted and received by a plurality of antennas based on the propagation path status, and to select the number of the antennas based on the properties of the information. Another method is to select the number of the antennas based on the propagation path status, and to select the information transmitted and received by a plurality of antennas based on the transmission information.

(First Embodiment)

In the first embodiment, information transmitted and received by a plurality of antennas is selected based on the propagation path status, and the number of the antennas is selected based on the properties of the transmission information.

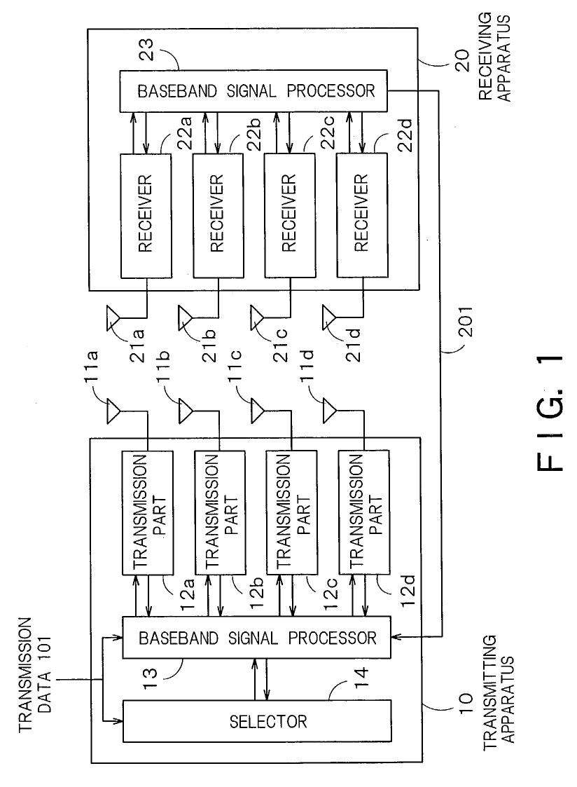

FIG. 1 is a block diagram showing schematic configuration of a first embodiment of a wireless communication system according to the present invention. The wireless communication system of FIG. 1 has a transmitting apparatus 10 having a plurality of transmission antennas 11a-11d, and a receiving apparatus 20 having a plurality of reception antennas 21a-21d.

The transmitting apparatus 10 has a plurality of transmitters provided for the transmission antennas 11a-11d, respectively, a baseband signal processor 13 and a selector 14. The receiving apparatus 20 has a plurality of receivers 22a-22d provided for the reception antennas 21a-21d, respectively and a baseband signal processor 23.

Transmission data 101 inputted to the transmitting apparatus 10 is provided to the baseband signal processor 13 and the selector 14. The selector 14 selects the number of the antennas and the information transmitted and received by a plurality of antennas.

The selection result of the selector 14 is transmitted to the baseband signal processor 13. The baseband signal processor 13 performs a prescribed signal processing based on the selection result of the number of the antennas and the selection result of the information transmitted and received by a plurality of antennas transmitted from the selector 14.

The signal after the signal processing is transmitted from one of the transmission antennas 11a-11d via at least one of four transmission parts 12a-12d.

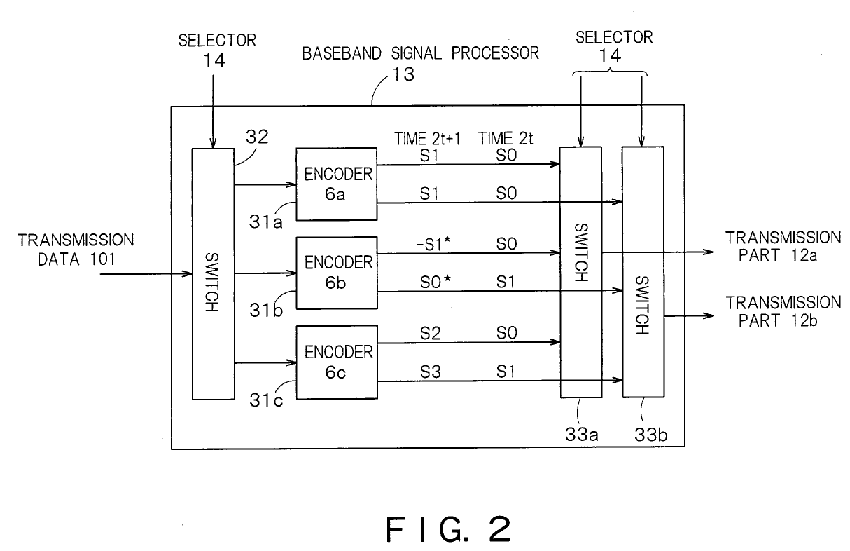

FIG. 2 is a block diagram showing one example of internal configuration of the baseband signal processor 13. Because of simplification of drawing, FIG. 2 shows block configurations in the case of having two transmission antennas.

As shown in FIG. 2, the baseband signal processor 13 has a plurality of encoders for encoding the transmission data, a switch 32 for selecting a plurality of encoders, and a plurality of switches 33a and 33b for selecting and outputting the transmission symbols encoded by a plurality of encoders 31a-31c.

A plurality of switches 33a and 33b are connected to the transmitters different from each other. The switch 32 performs the selection operation based on the signal from the selector 14.

The encoder 31a outputs the encoding data so that the same transmission symbol S1 is outputted from two transmission antennas. The encoder 31b outputs the encoding data at time 2t (even turns) so that the transmission symbol S0 is outputted from one transmission antenna, and the transmission symbol S1 is outputted from another transmission antenna. The encoder 31b outputs the encoding data at odd turns so that the transmission symbol −S1* is outputted from one transmission antenna, and the transmission symbol S1 is outputted from another transmission antenna. The “*” means a complex conjugate.

The receiving apparatus 20 receives the transmission signal from the transmitter 10 in at least one of the reception antennas 21a-21d, and then transmits the received signal to the baseband signal processor 23 via the corresponding receivers. The baseband signal processor 23 performs a prescribed signal processing and then outputs the received signal. The baseband signal processor 23 transmits a feedback signal 201 indicating the propagation path status and properties of transmission information to the transmitting apparatus 10.

When the transmission symbols encoded by the encoder 31b is received, the receiving apparatus 20 decodes the transmission symbols by using a method disclosed in U.S. Pat. No. 6,185,258, thereby improving transmission quality. When the transmission symbols encoded by the encoder 31c is received, the receiving apparatus 20 separates the transmission symbols by using the method disclosed in U.S. Pat. No. 6,097,771, thereby improving transmission efficiency.

The selector 14 of the present embodiment selects the number of antennas and the information transmitted and received by a plurality of antennas, based on the propagation path status and the properties of the transmission information. More specifically, the selector 14 selects the information transmitted and received by a plurality of antennas based on the propagation path status and selects the number of antennas based on the properties of the transmission information.

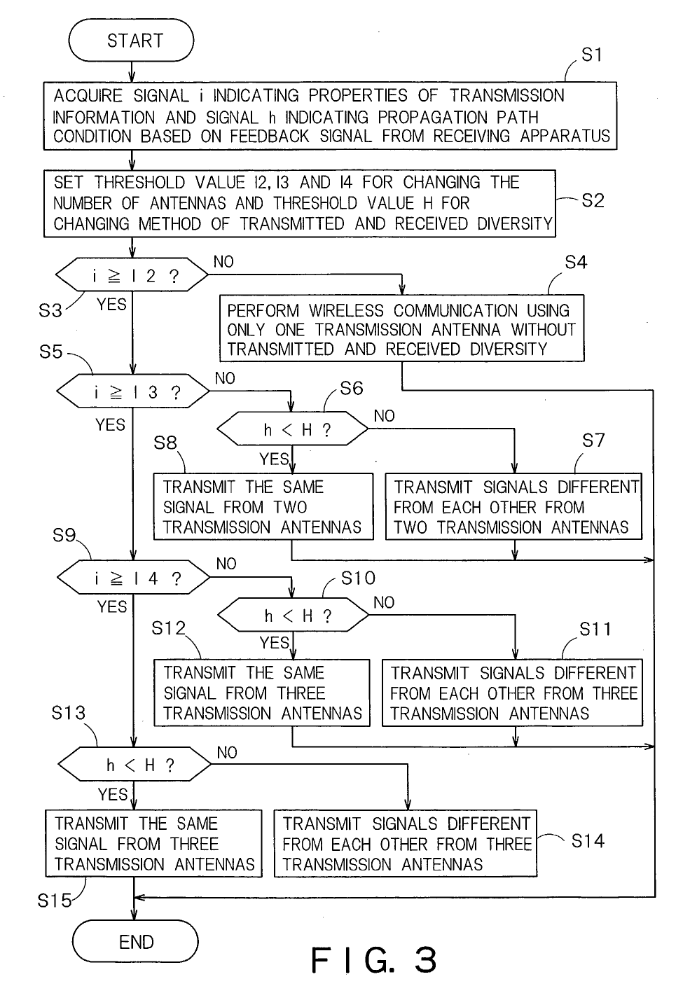

FIG. 3 is a flowchart showing processing procedures of the selector 14 in the first embodiment. In FIG. 3, a method of transmitted and received diversity is selected based on the propagation path status, and the number of antennas is selected based on the properties of the transmission information.

First of all, a signal i indicating the properties of the transmission information and a signal h indicating the propagation path status are acquired (step S1).

Threshold values I2, I3 and I4 (I2<I3<I4) for variably changing the number of the antennas, and a threshold value H for variably changing the method of the transmitted and received diversity are set (step S2). The threshold values I2, I3 and I4 are determined based on the types of the transmission signals such as voice, data and streaming data. The threshold value H is determined by using a ratio of signal power to noise power, a ratio of signal power to interference power, or a correlation value of the propagation path status.

It is determined whether or not the signal i indicating the properties of the transmission information is no less than the threshold value I2 (step S3). If not i≧I2, instead of the transmitted and received diversity using a plurality of transmission antennas 11a-11d, the wireless communication using only one transmission antenna is performed (step S4).

If determined to be “yes” in step S2, it is determined to be i≧I3 (step S5). If determined to be “no”, two transmission antennas are used, and it is determined that the signal h indicating the propagation path status is less than a threshold value H (step S6).

If no less than the threshold value H, it is determined that the propagation path status is good, and the signals different from each other are transmitted from two transmission antennas, for example, alike the space-time coding (STC) (step S7). If less than the threshold value H, it is determined that the propagation path status is bad, and the same signal is transmitted from two transmission antennas (step S8). The processings of steps S7 and S8 are performed by switching signals by the switch 32 of the baseband signal processor 13 of FIG. 2 based on the signal from the selector 14.

On the other hand, if determined to be “yes” in step S5, it is determined whether or not to be i≧I4 (step S9). If determined to be “no”, it is determined to use three transmission antennas. Next, it is determined whether or not the signal h indicating the propagation path status is less than a threshold value H (step S10). If no less than the threshold value H, three transmission antennas transmit the signals different from each other (step S11). If less than the threshold value H, three transmission antennas transmit the common signal from three transmission antennas, respectively (step S12).

If determined to be “yes” in step S9, four transmission antennas 11a-11d are used. It is determined whether or not the signal h indicating the propagation path status is less than the threshold value H (step S13). If no less than the threshold value H, four transmission antennas 11a-11d transmit from the transmission antennas 11a-11d the signals different from each other, respectively (step S14). If less than the threshold value H, four transmission antennas 11a-11d transmit the same signal, respectively (step S15).

The above-mentioned processings of steps S7, S11 and S14 of FIG. 3 may be performed by the encoders 31b and 31c of FIG. 2.

In the flowchart of FIG. 3, the number of the used transmission antennas 11a-11d is gradually increased based on the signal i indicating the properties of the information. However, the number of the used transmission antennas 11a-11d may be gradually decreased.

According to the first embodiment, the information transmitted and received by a plurality of antennas is selected based on the propagation path status, and the number of the antennas is selected based on the properties of the transmission information. Because of this, it is possible to change the number of the used antennas based on the properties of the information, thereby performing the wireless communication suitable for required quality.

(Second Embodiment)

In a second embodiment, the number of antennas is selected based on the propagation path status, and information transmitted and received by a plurality of antennas is selected based on properties of transmission information. Since the second embodiment has the same block configurations as those of first embodiment, description of the block configurations will be omitted.

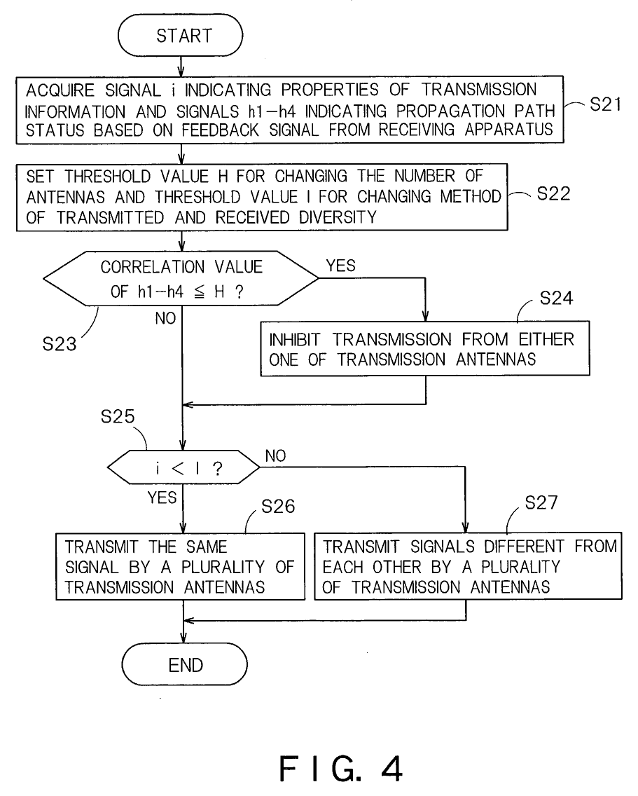

FIG. 4 is a flowchart showing processing procedure of the selection part 14 in the second embodiment. FIG. 4 shows a processing procedure in which the number of the antennas is selected based on the propagation path status, and the information transmitted and received by a plurality of antennas is selected.

First of all, the signal i indicating the properties of the transmission information and the signals h1-h4 indicating the propagation path status are acquired based on a feedback signal 201 from the receiving apparatus 20 (step S21). The threshold value H for variably changing the number of the antennas and a threshold value I for variably changing the transmitted and received diversity system are set (step S22). The threshold value H is set based on the ratio of signal power to noise power, the ratio of signal power to interference power, or a correlation value of the propagation path status. The threshold value I is set based on properties of transmission information such as voice, data and streaming data.

It is determined whether or not the correlation value of the signals h1-h4 indicating the propagation path status is no more than the threshold value H (step S23). If the correlation value is no more than the threshold value H, transmission from either one of the transmission antennas is inhibited (step S24). For example, the correlation value between the signals h2 and h3 indicating the propagation path status is no more than the threshold value, either one of the transmission antenna corresponding to the signal h2 or the transmission antenna corresponding to the signal h3 is not used.

It is determined that the signal i indicating the properties of the information is less than the threshold value I (step S25). If less than the threshold value, the same signal is transmitted by a plurality of transmission antennas 11a-11d (step S26). If no less than the threshold value, the signals different from each other are transmitted from a plurality of transmission antennas 11a-11d (step S27).

According to the second embodiment, the number of antennas is selected based on the propagation path status, and the information transmitted and received by a plurality of antennas is selected based on the properties of the transmission information. Because of this, with regard to information in which the amount of information such as voice is small, but instantaneity is required, a plurality of transmission antennas 11a-11d are used for transmitting the same information. With regard to information in which the amount of information such as data and moving image is large, but instantaneity is not so much required, a plurality of transmission antennas 11a-11d transmit the information different from each other.

In the second embodiment, it is possible to arbitrarily change methods of transmitting and receiving the wireless signal.

(Third Embodiment)

In a third embodiment, a threshold inherent in each user is set.

For example, in the second embodiment, when a user A performs communication of high priority and communication having a large amount of information such as moving image, the threshold values I2, I3 and I4 in steps S3, S5 and S9 are set lower.

On the other hand, when a user B performs communication of low priority, and communication of the same information as that of user A, the threshold values I2, I3 and I4 in steps S3, S5 and S9 of FIG. 3 are set large. Therefore, user A can accept more allocation of the transmission antennas 11a-11d than user B, thereby performing communication by priority.

According to the third embodiment, since the threshold value is individually set for each user, it is possible to perform wireless communication in order of priority for each user. It is possible to perform wireless communication in accordance with availability of users.

(Fourth Embodiment)

In a fourth embodiment, history information of the threshold value is stored, and the threshold value is set with reference to previous threshold value.

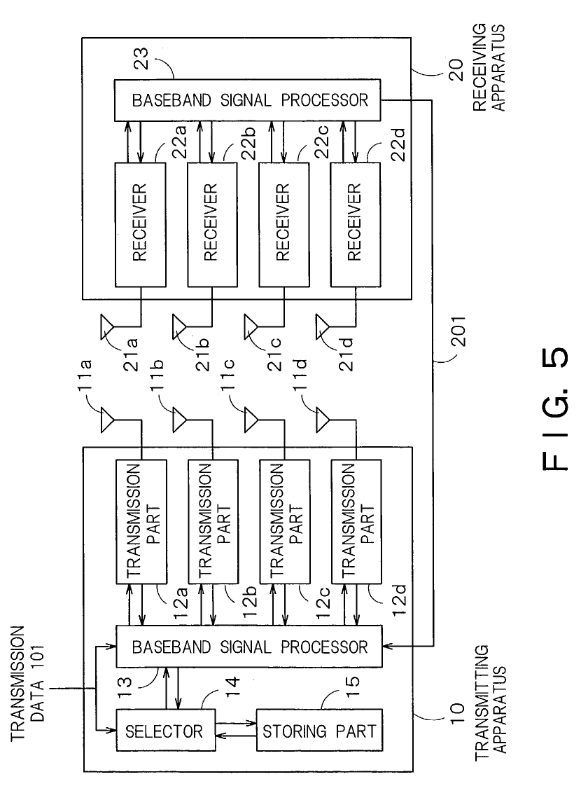

FIG. 5 is a block diagram showing schematic configuration of a fourth embodiment of a wireless communication system according to the present invention. In FIG. 5, the same reference numbers are attached to the common constituents as those of FIG. 1. Hereinafter, different points will be mainly described.

The transmitting apparatus 10 of FIG. 5 has a storage 15, in addition to configurations of FIG. 1. The storage 15 stores previous changing history information of the threshold value for variably changing the number of antennas and the threshold value for variable changing the transmitted and received information.

The selector 14 sets the above-mentioned threshold value based on the changing history information of the threshold value stored in the storage 15.

According the fourth embodiment, new threshold value is set based on the previous changing history information of the threshold value. Because of this, there is no likelihood to mistake the setting of the threshold value, thereby easily and quickly setting an optimum threshold value.

In the above-mentioned embodiment, the example in which the maximum number of antennas is four, the threshold values for selecting the antennas is provided three, the number of selecting the information transmitted and received by a plurality of antennas is two, and the number of selecting the threshold value in the case is one has been described. However, these numbers are not limited to the above-mentioned embodiment. For example, the maximum number of antennas is N, the number of selecting the information transmitted and received by a plurality of antennas is L, the number of selecting the threshold values for changing the number of antennas is (N−1), and the number of selecting the threshold value to change the selection of the information transmitted and received by a plurality of antennas may be provided (L−1). The threshold values may be changed for every one constant time period, or for each time when the information is transmitted. Or the threshold values may be changed by random.

What is claimed is:

1. A wireless transmitting apparatus, comprising:
N (N is two or more integer) pieces of antennas capable of transmitting a wireless signal; and
a selector which selects L (L is one or more integer, and L≦N) pieces of antennas from said N pieces of antennas and selects the types of signals to be transmitted from the selected L pieces of antennas.

2. The wireless transmitting apparatus according to claim 1,
wherein said selector selects said L pieces of antennas based on properties of the transmitted wireless signals and selects the types of signals to be transmitted from said L pieces of antennas based on a status of the propagation paths of the wireless signals.

3. The wireless transmitting apparatus according to claim 1,
wherein said selector selects said L pieces of antennas based on a status of propagation paths of the wireless signals and selects the types of signals to be transmitted from said L pieces of antennas based on properties of the transmitted wireless signal.

4. The wireless transmitting apparatus according to claim 1, comprising:
a plurality of encoders which encodes transmission data;
N pieces of transmitters which are provided corresponding to said N pieces of antennas and supply transmission data to the corresponding antenna; and
a plurality of switches which distribute outputs of said encoders to said N pieces of transmitters.

5. The wireless transmitting apparatus according to claim 1, comprising:
a threshold value setting part which sets a first threshold value which selects said L pieces of antennas and a second threshold value which sets types of signals to be transmitted from said L pieces of antennas; and
a control information detector which detects a first control value which indicates a status of propagation path of the wireless signals and a second value which indicates properties of the wireless signal transmitted from said L pieces of antennas,
wherein said selector selects said L pieces of antennas and the types of signals to be transmitted from said L pieces of antennas, based on said first and second threshold values, and said first and second control values.

6. The wireless transmitting apparatus according to claim 5, wherein said control information detector detects said first and second control values based on a feedback signal from a receiving apparatus which receives the transmission signal from said L pieces of antennas.

7. The wireless transmitting apparatus according to claim 5,
wherein said selector selects said L pieces of antennas based on a compared result between said second control value and said first threshold value, and selects the types of signals to be transmitted from said L pieces of antennas based on a compared result between said first control value and said second threshold value.

8. The wireless transmitting apparatus according to claim 7,
wherein said first threshold value includes a plurality of threshold values each having different a reference value; and
said selector selects said L pieces of antennas based on a compared result between said second control value and said reference values.

9. The wireless transmitting apparatus according to claim 5,
wherein said selector increases the number of antennas to be transmitted, as said second control value is larger.

10. The wireless transmitting apparatus according to claim 5,
wherein said selector allows the same signal to transmit from said L pieces of antennas if said first control value is less than said second threshold value, and allows signals different from each other to transmit from said L pieces of antennas if said first control value is no less than said second threshold value.

11. The wireless transmitting apparatus according to claim 5,
wherein said selector selects said L pieces of antennas based on a compared result between said first control value and said first threshold value, and selects the types of signals to be transmitted from said L pieces of antennas based on a compared result between said second control value and said second threshold value.

12. The wireless transmitting apparatus according to claim 5,
wherein said selector stops wireless transmission from at least one of said N pieces of antennas when said first control value is no more than said first threshold value.

13. The wireless transmitting apparatus according to claim 5,
wherein said selector transmits the same signal from said L pieces of antennas if said second control value is less than said second threshold value, and transmits signals different from each other from said L pieces of antennas if said second control value is no less than said second threshold value.

14. The wireless transmitting apparatus according to claim 5, further comprising:
a threshold value storage which stores said first and second threshold values set previously,
wherein said threshold value setting part sets new first and second threshold values based on said first and second threshold values stored in said threshold value storage.

15. The wireless transmitting apparatus according to claim 1,
wherein properties of said wireless signal include at least one of binary data, image, sound and streaming data.

16. A wireless communication system, comprising:
a transmitting apparatus having N (N is two or more integer) pieces of transmission antennas; and
a receiving apparatus having N pieces of reception antennas,
wherein said transmitting apparatus selects L (L≦N) pieces of transmission antennas among said N pieces of transmission antennas, based on a propagation path status of said N pieces of transmission antennas and properties of the wireless signal; and
said receiving apparatus receives the signal transmitted from said L pieces of transmission antennas at a diversity branch.

17. The wireless communication system according to claim 16,
wherein said receiving apparatus has a feedback signal transmitter which sends back the transmission signal from said transmitting apparatus to said transmitting apparatus as a feedback signal;
said transmitting apparatus has a control information detector which detects a first control value indicating the propagation path status and a second control value indicating the properties of the wireless signal transmitted from said L pieces of transmission antennas, based on said feedback signal; and
said selector selects said L pieces of transmission antennas and the types of signals to be transmitted from said L pieces of transmission antennas, based on said first and second control values.

18. The wireless communication system according to claim 16,
wherein said selector selects said L pieces of antennas based on the properties of the transmitted wireless signal, and selects the types of signals transmitted from said L pieces of antennas based on the propagation path status.

19. The wireless communication system according to claim 16,
wherein said selector selects said L pieces of antennas based on the propagation path status and selects the types of signals to be transmitted from said L pieces of antennas based on the properties of the transmitted wireless signal.

20. A method of wireless transmission, comprising:
selecting L (L is one or more, and L≦M) pieces of antennas among N (N is one or more integer) pieces of antennas based on a propagation path status of wireless signals transmitted from said N pieces of antennas capable of transmitting the wireless signals and properties of the transmitted wireless signal, and selecting the types of signals to be transmitted from the selected L pieces of antennas.
